(19) United States
(12) Patent Application Publication
(10) Pub. No.: US 2026/0342235 A1
(43) Pub. Date: Oct. 29, 2026

(54) POWER SUPPLY CONTROLLER AND SWITCHING POWER SUPPLY

(71) Applicant: Rohm Co., Ltd., Kyoto (JP)

(72) Inventor: Isao TAKOBE, Kyoto (JP)

(21) Appl. No.: 19/650,673

(22) Filed: Apr. 17, 2026

(30) Foreign Application Priority Data
Apr. 23, 2025 (JP) 2025-071725

(51) Int. Cl. H02M 3/335; H02M 1/00; H02M 3/00

(52) U.S. Cl. CPC H02M 3/33571; H02M 1/0025; H02M 3/01

(57) ABSTRACT

A power supply controller for controlling an operation of an LLC resonant converter including a first switch element, a second switch element, and a primary winding, the power supply controller including: a monitor terminal configured to receive a current sense signal corresponding to a current flowing through the primary winding; a voltage source configured to generate a reference voltage that increases in a slope shape in activation; and a control circuit configured to perform: a first control where the first switch element is set to an off-state, and the second switch element is set to an on-state for a constant time in the activation, and a second control where the first switch element is set to an on-state and the second switch element is set to an off-state after performing the first control, and when the current sense signal exceeds the reference voltage, the first switch element is turned off.

### CROSS-REFERENCE TO RELATED APPLICATION

This application is based upon and claims the benefit of priority from Japanese Patent Application No. 2025-071725, filed on Apr. 23, 2025, the entire contents of which are incorporated herein by reference.

### TECHNICAL FIELD

The present disclosure relates to a power supply controller and a switching power supply.

### BACKGROUND

The present applicant has proposed numerous new technologies regarding LLC resonant DC/DC converters (hereinafter, also referred to as LLC resonant converters).

### BRIEF DESCRIPTION OF DRAWINGS

The accompanying drawings, which are incorporated in and constitute a part of the specification, illustrate embodiments of the present disclosure.

FIG. 1 is a diagram showing a configuration of a switching power supply according to an embodiment of the present disclosure.

FIG. 2 is an external perspective view of a semiconductor device.

FIG. 3 is a diagram for explaining an operation of a switching power supply in a first mode.

FIG. 4 is a diagram for explaining an operation of a switching power supply in a second mode.

FIG. 5 is a diagram for explaining an operation of a switching power supply in a third mode.

FIG. 6 is a diagram for explaining an operation of a switching power supply in a fourth mode.

FIG. 7 is a diagram for explaining an operation of a switching power supply in a fifth mode.

FIG. 8 is a diagram for explaining an operation of a switching power supply in a sixth mode.

FIG. 9 is a diagram for explaining an operation of a switching power supply in a seventh mode.

FIG. 10 is a diagram for explaining an operation of a switching power supply in an eighth mode.

FIG. 11 is a diagram for explaining an operation of a switching power supply in a ninth mode.

FIG. 12 is a diagram for explaining an operation of a switching power supply in a tenth mode.

FIG. 13 is a diagram showing operation waveforms of a switching power supply.

FIG. 14 is a diagram showing a configuration example of a voltage source.

FIG. 15 is a diagram showing a modification example of a switching power supply according to an embodiment of the present disclosure.

FIG. 16 is a diagram showing another modification example of a switching power supply according to an embodiment of the present disclosure.

### DETAILED DESCRIPTION

### <Configuration of Switching Power Supply>

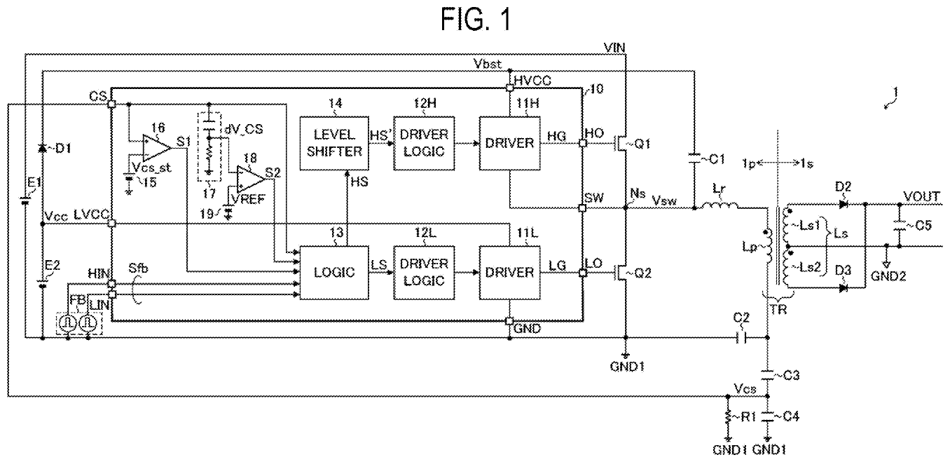

FIG. 1 is a diagram showing a configuration of a switching power supply according to an embodiment of the present disclosure. A switching power supply 1 includes an LLC resonant insulation DC/DC converter configured to generate a desired DC output voltage VOUT from a DC input voltage VIN while electrically insulating between a primary circuit system 1p (GND1 system) and a secondary circuit system 1s (GND2 system).

The switching power supply 1 includes voltage sources E1 and E2, a semiconductor device 10, an output feedback circuit FB, and various discrete components (an upper switch element Q1, a lower switch element Q2, a transformer TR, capacitors C1 to C5, diodes D1 to D3, and an inductor Lr). In FIG. 1, the upper switch element Q1 and the lower switch element Q2 are N channel type switch elements, but may be switch elements of any type other than the N channel type.

In a case where an AC input voltage is input to the switching power supply 1, a front-stage circuit (such as a diode bridge or a power factor correction circuit) configured to rectify and smooth the AC input voltage to generate a DC input voltage VIN may be provided instead of the voltage source E1.

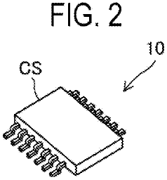

The semiconductor device 10 is a control entity of the switching power supply 1 (so-called power supply controller). The semiconductor device 10 includes a plurality of external terminals (an HVCC pin, an HO pin, an SW pin, an LO pin, a GND pin, an LIN pin, an HIN pin, an LVCC pin, and a CS pin) so as to establish electrical connection with the outside of the device. FIG. 2 is an external perspective view of the semiconductor device 10. The semiconductor device 10 is an electronic component including a semiconductor chip including a semiconductor integrated circuit formed on a semiconductor substrate, a housing CS (package) accommodating the semiconductor chip, and a plurality of external terminals exposed to the outside of the semiconductor device 10 from the housing CS. The semiconductor device 10 is formed by encapsulating the semiconductor chip in the housing CS made of a resin. The number of the external terminals of the semiconductor device 10 and the kind of the housing CS of the semiconductor device 10 as shown in FIG. 2 are merely examples and may be designed as desired. The HVCC pin, the HO pin, the SW pin, the LO pin, the GND pin, the LIN pin, the HIN pin, the LVCC pin, and the CS pin are some of the above-described plurality of external terminals provided on the semiconductor device 10. External terminals other than these terminals may also be provided on the semiconductor device 10.

The transformer TR includes a primary winding Lp provided in the primary circuit system 1p, and a secondary winding Ls that is provided in the secondary circuit system 1s and is magnetically coupled to the primary winding Lp.

A first end (in FIG. 1, a winding start end) of the primary winding Lp is connected to a first end of the inductor Lr. A second end of the inductor Lr is connected to a connection node Ns between a source of the upper switch element Q1 and a drain of the lower switch element Q2. The second end of the inductor Lr is also connected to an SW pin of the semiconductor device 10. A second end (in FIG. 1, a winding terminal end) of the primary winding Lp is connected to a first end of the capacitor C2 and a first end of the capacitor C3. A second end of the capacitor C2 is connected to a source of the lower switch element Q2, a GND pin of the semiconductor device 10, and a ground end of the primary circuit system 1p (=an application end of a ground voltage GND1). A second end of the capacitor C3 is connected to a first end of the capacitor C4, a first end of a resistor R1, and the CS pin of the semiconductor device 10. A second end of the capacitor C4 and a second end of the resistor R1 are connected to the ground end of the primary circuit system 1p. The capacitors C3 and C4 capacitively divide a voltage generated at a connection node between the primary winding Lp and the capacitor C2 to generate a voltage Vcs. The voltage Vcs is a signal (a current sense signal) including information of a current flowing through the primary winding Lp. The voltage Vcs becomes a signal that swings between positive and negative due to the resistor R1 with its second end connected to the ground end (0 V) of the primary circuit system 1p.

The transformer TR may be a leakage transformer or a resonance transformer. That is, the inductor Lr may be a leakage inductance of the transformer TR.

A first end (for example, a winding start end) of a secondary winding Ls1 is connected to an anode of the diode D2. A first end (for example, a winding terminal end) of a secondary winding Ls2 is connected to an anode of the diode D3. A cathode of each of the diodes D2 and D3, and a first end of the capacitor C5 are connected to an application end of a DC output voltage VOUT. A second end (for example, a winding terminal end) of the secondary winding Ls1, a second end (for example, a winding start end) of the secondary winding Ls2, and a second end of the capacitor C5 are connected to a ground end of the secondary circuit system 1s (=an application end of a ground voltage GND2). The secondary windings Ls1 and Ls2 may be understood as a single secondary winding Ls with a center tap.

In addition, the transformer TR, the inductor Lr, the diodes D2 and D3, the capacitors C2 and C5, the upper switch element Q1, and the lower switch element Q2 connected as described above form an LLC resonant switching output stage configured to generate a desired DC output voltage VOUT from a DC input voltage VIN. In particular, the diodes D2 and D3 and the capacitor C5 function as a rectifying and smoothing circuit configured to rectify and smooth an induced voltage generated in the secondary winding Ls to generate a DC output voltage VOUT.

A positive end (=an application end of the DC input voltage VIN) of the voltage source E1 is connected to a drain of the upper switch element Q1. A positive end (=an application end of a power supply voltage Vcc) of the voltage source E2 and an anode of the diode D1 are connected to the LVCC pin of the semiconductor device 10. Negative ends of the voltage sources E1 and E2 are connected to the GND pin (=an application end of the ground voltage GND1) of the semiconductor device 10. The cathode of the diode D1 and a first end of the capacitor C1 are both connected to the HVCC pin (=an application end of a boosted voltage Vbst) of the semiconductor device 10. The second end of the capacitor C1 is connected to connection node Ns.

The diode D1 and the capacitor C1 connected as described above function as a bootstrap circuit configured to generate the boosted voltage Vbst, which is always higher than a switch voltage Vsw applied to the connection node Ns, by a voltage VC between both ends of the capacitor C1 (≈Vcc−Vf, provided that Vf is a forward drop voltage of the diode D1). In other words, when Vsw≈0 V (GND1), Vbst≈VC, and when Vsw≈VIN, Vbst≈VIN+VC.

The output feedback circuit FB generates a feedback signal Sfb corresponding to the DC output voltage VOUT and outputs the feedback signal Sfb to the HIN pin and the LIN pin of the semiconductor device 10. The output feedback circuit FB may have any circuit configuration. For example, the output feedback circuit FB generally has a configuration using a shunt regulator and a photocoupler, or a configuration using an auxiliary winding of the transformer TR.

A gate of the upper switch element Q1 is connected to the HO pin (=an application end of an upper gate signal HG) of the semiconductor device 10. The upper switch element Q1 enters an on-state when the upper gate signal HG is at a high level (Vbst), and enters an off-state when the upper gate signal HG is at a low level (≈Vsw).

A gate of the lower switch element Q2 is connected to the LO pin (=application end of a lower gate signal LG) of the semiconductor device 10. The lower switch element Q2 enters an on-state when the lower gate signal LG is at a high level (≈Vcc), and enters an off-state when the lower gate signal LG is at a low level (≈GND1).

The upper switch element Q1 and the lower switch element Q2 may be, for example, Si devices or GaN devices. The GaN device may be a device that combines a high electron mobility transistor (GaN-HEMT) and a metal oxide semiconductor field effect transistor (MOSFET). The term “MOSFET” in the present disclosure refers to a field effect transistor whose gate structure is constituted by at least three layers of “a layer made of a conductor or a semiconductor such as polysilicon with a low resistance value,” “an insulating layer,” and “a P-type, N-type, or intrinsic semiconductor layer.” In other words, the gate structure of the MOSFET is not limited to a three-layer structure of a metal, an oxide, and a semiconductor.

In FIG. 1, each of the upper switch element Q1 and the lower switch element Q2 is externally attached to the semiconductor device 10 as a discrete element, but the elements may also be built in the semiconductor device 10 as integrated elements.

### <Configuration of Semiconductor Device>

The semiconductor device 10 includes an upper driver 11H, a lower driver 11L, an upper driver logic 12H, a lower driver logic 12L, a logic 13, a level shifter 14, a voltage source 15, a comparator 16, a high-pass filter 17, and a comparator 18.

The upper driver 11H generates an upper gate signal HG. The upper driver 11H is connected to the HVCC pin, the SW pin, and the HO pin.

The lower driver 11L generates a lower gate signal LG. The lower driver 11L is connected to the LVCC pin, the GND pin, and the LO pin.

The upper driver logic 12H controls an operation of the upper driver 11H in response to a level-shifted upper control signal HS′. For example, when the level-shifted upper control signal HS′ is at a high level, the upper driver logic 12H controls the operation of the upper driver 11H such that the upper gate signal HG is at a high level. On the other hand, when the level-shifted upper control signal HS′ is at a low level, the upper driver logic 12H controls the operation of the upper driver 11H such that the upper gate signal HG is at a low level.

The lower driver logic 12L controls an operation of the lower driver 11L in response to a lower control signal LS. For example, when the lower control signal LS is at a high level, the lower driver logic 12L controls the operation of the lower driver 11L such that the lower gate signal LG is at a high level. On the other hand, when the lower control signal LS is at a low level, the lower driver logic 12L controls the operation of the lower driver 11L such that the lower gate signal LG is at a low level.

The logic 13 generates an upper control signal HS and the lower control signal LS so as to control each of the upper switch element Q1 and the lower switch element Q2 to be turned on and off in a complementary manner in response to a feedback signal Sfb input to the HIN pin and the LIN pin.

The term “complementary” in the present disclosure may be broadly interpreted to include not only a case where on/off states of the upper switch element Q1 and the lower switch element Q2 are completely reversed, but also a case where a delay is applied to on/off transition timings of the upper switch element Q1 and the lower switch element Q2 (a case where a so-called simultaneous off period (dead time) is provided).

Existing known techniques (such as a voltage mode control method, a current mode control method, or a hysteresis control method) are applicable to the output feedback control by the logic 13. When the current mode control method is applied, the logic 13 generates the upper control signal HS and the lower control signal LS in response to the feedback signal Sfb input to the HIN pin and the LIN pin, and the voltage Ves input to the CS pin.

The level shifter 14 shifts a signal level of the upper control signal HS to generate a level-shifted upper control signal HS′.

The voltage Vcs input to the CS pin is applied to a non-inverting input end of the comparator 16. A reference voltage Vcs_st output from the voltage source 15 is applied to an inverting input end of the comparator 16. The reference voltage Vcs_st is a voltage that increases in a slope shape in activation of the switching power supply 1. The high-pass filter 17 includes a capacitor and a resistor, receives the voltage Vcs input to the CS pin, converts the voltage Vcs to a voltage dV_CS, and supplies the voltage dV_CS to the inverting input end of the comparator 18. A reference voltage (constant voltage) VREF output from the voltage source 19 is applied to a non-inverting input end of the comparator 18. A comparison result signal S1 output from the comparator 16 and a comparison result signal S2 output from the comparator 18 are supplied to the logic 13. The logic 13 uses the comparison result signals S1 and S2 to perform control in activation described below.

### <Basic Operation of Switching Power Supply>

The switching power supply 1 controls the DC output voltage VOUT by using a frequency modulation method that changes a switching frequency fsw of each of the upper switch element Q1 and the lower switch element Q2. The switching power supply 1 has a resonant frequency fsr expressed by following Equation (1) and a resonant frequency fpr expressed by following Equation (2). In following Equations (1) and (2), Lr is an inductance of the inductor Lr, Cr in following Equations (1) and (2) is a capacitance of the capacitor C2, and Lm in following Equation (2) is an inductance of the primary winding Lp.

$$\begin{matrix}[ Equation ] & \\ fsr = \frac{1}{2 π \sqrt{LrCr}} & ( 1 )\end{matrix}$$

$$fpr = \frac{1}{2 π \sqrt{( Lr + Lm ) Cr}} \qquad ( 2 )$$

When the switching frequency fsw is set to be higher than the resonant frequency fpr and lower than the resonant frequency fsr, and a gain (=VOUT/VIN) in the switching power supply 1 is greater than 1, the switching power supply 1 repeatedly operates in the following first to tenth modes.

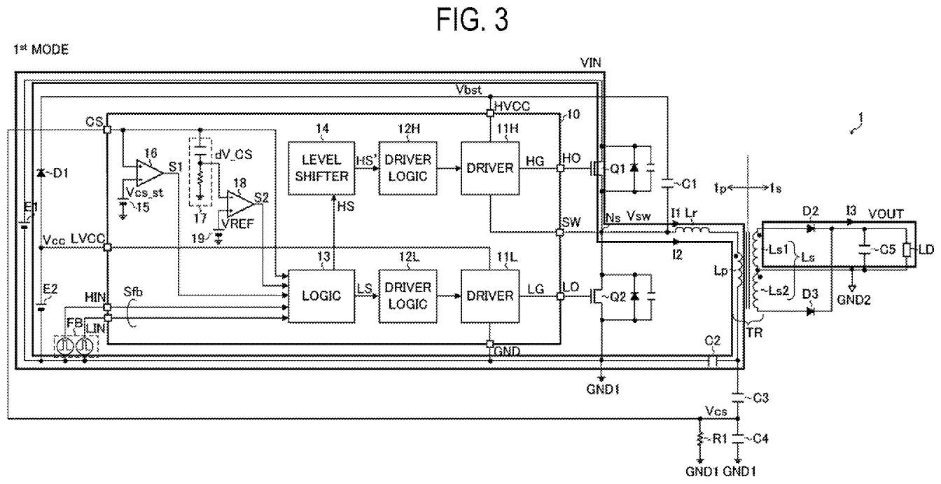

In the first mode, the upper switch element Q1 enters the on-state, and the lower switch element Q2 enters the off-state. As shown in FIG. 3, a load current I1 and an excitation current I2 flow in the primary circuit system 1p, and a load current I3 flows in the secondary circuit system 1s via the diode D2. The load current I3 is a sinusoidal current due to resonance between the inductor Lr and the capacitor C2. When the load current I3 becomes 0 A, the operation of the switching power supply 1 transitions from the first mode to the second mode.

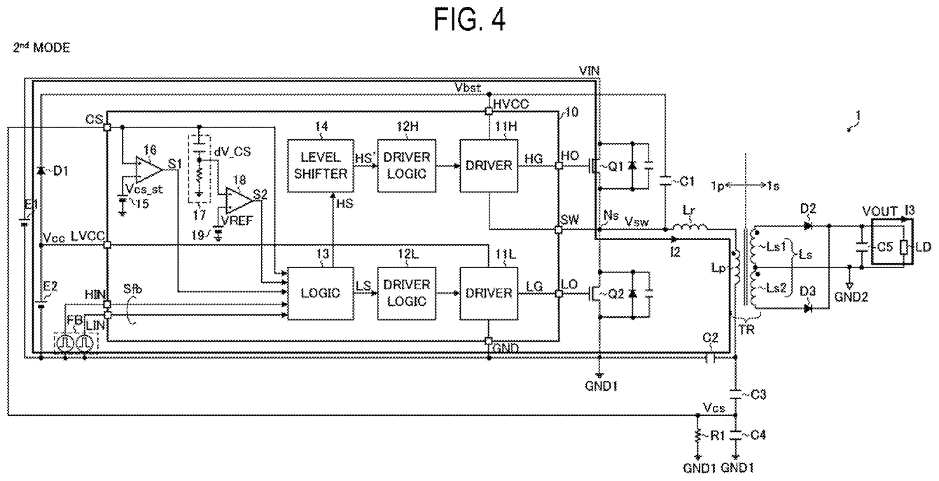

In the second mode, as in the first mode, the upper switch element Q1 enters the on-state and the lower switch element Q2 enters the off-state. As shown in FIG. 4, in the primary circuit system 1p, the load current I1 becomes 0 A, but the excitation current I2 continues to flow, and in the secondary circuit system 1s, the load current I3 flows from capacitor C5 to a load LD. The capacitor C2 is charged by the excitation current I2. The longer a period of the second mode, that is, the longer a charging period of the capacitor C2, the greater an amount of charges stored in the capacitor C2, such that the DC output voltage VOUT rises.

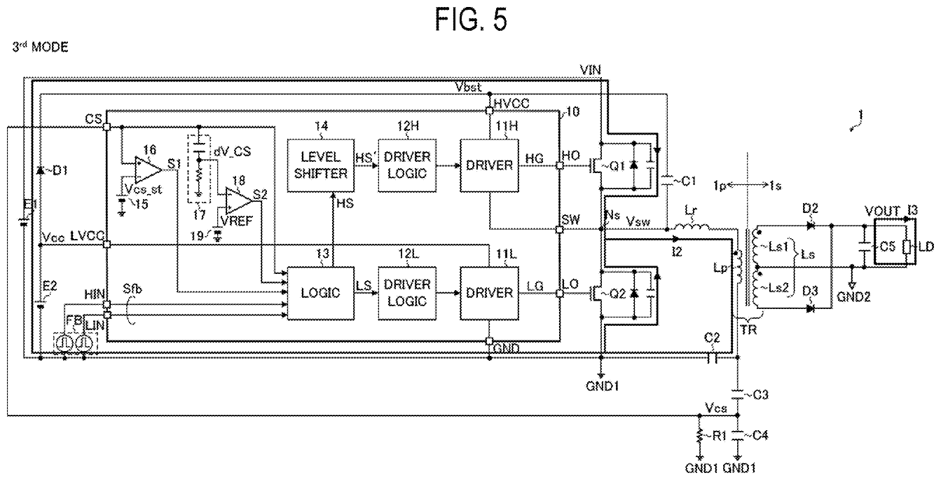

In the third mode subsequent to the second mode, the upper switch element Q1 switches from the on-state to the off-state. As shown in FIG. 5, in the primary circuit system 1p, the excitation current I2 starts to charge an output capacitance of the upper switch element Q1, and at the same time, an output capacitance of the lower switch element Q2 starts to discharge, and in the secondary circuit system 1s, the load current I3 flows from the capacitor C5 to the load LD. When the charging of the output capacitance of the upper switch element Q1 and the discharging of the output capacitance of the lower switch element Q2 are completed, the operation of the switching power supply 1 transitions from the third mode to the fourth mode.

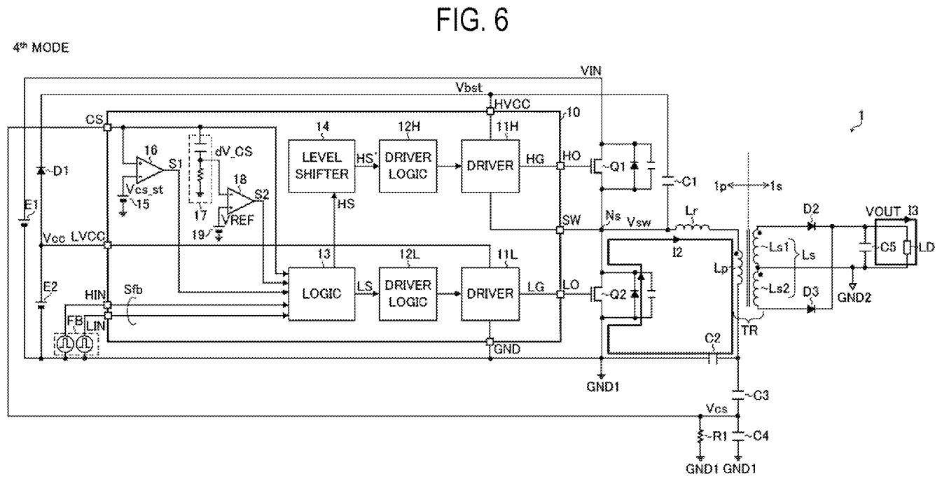

In the fourth mode, as shown in FIG. 6, in the primary circuit system 1p, the excitation current I2 flows through a body diode of the lower switch element Q2, and in the secondary circuit system 1s, the load current I3 flows from the capacitor C5 to the load LD. As the excitation current I2 flows through the body diode of the lower switch element Q2, a drain-source voltage of the lower switch element Q2 becomes approximately 0 V.

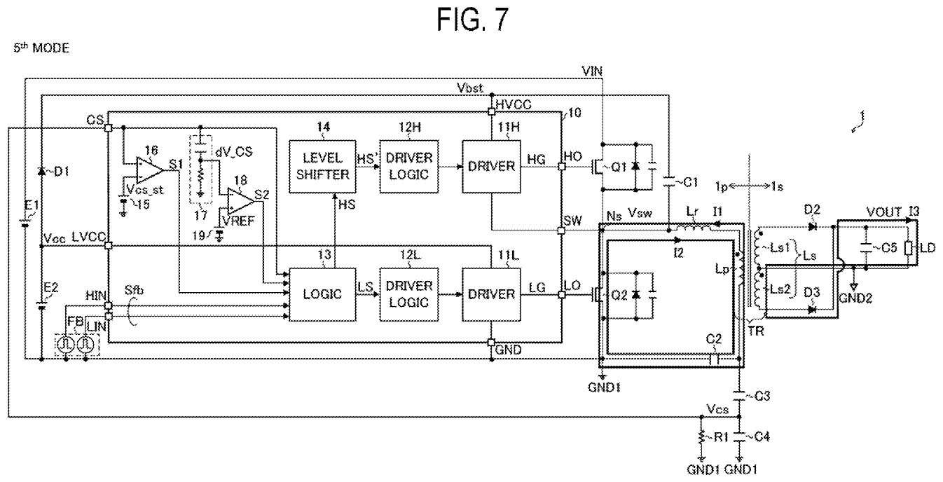

In the fifth mode subsequent to the fourth mode, the lower switch element Q2 switches from the off-state to the on-state. Since the excitation current I2 flows through the body diode of the lower switch element Q2 before the lower switch element Q2 switches from the off-state to the on-state, a turn-on operation of the lower switch element Q2 becomes a zero voltage switching (ZVS) operation. The capacitor C2 functions as a power supply by being charged. As a result, as shown in FIG. 7, the load current I1 is generated in the primary circuit system 1p, and the load current I3 flows in the secondary circuit system Is via the diode D3. The excitation current I2 flows in a direction opposite to a direction of the load current I1, but since a negative voltage is applied to the primary winding Lp, the excitation current I2 gradually decreases and eventually becomes a current in the same direction as in the load current I1.

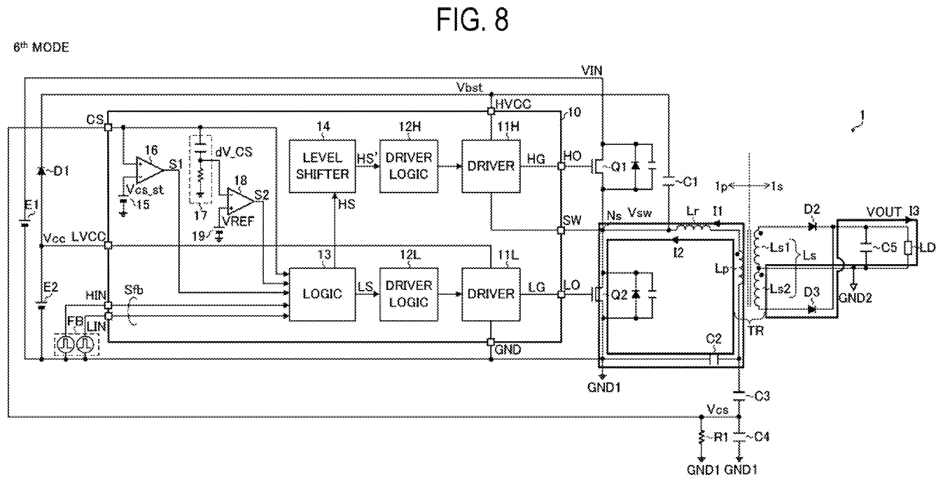

In the sixth mode subsequent to the fifth mode, the upper switch element Q1 enters the off-state and the lower switch element Q2 enters the on-state. As shown in FIG. 8, the load current I1 and the excitation current I2 flow in the primary circuit system 1p, and the load current I3 flows in the secondary circuit system Is via the diode D3. The load current I3 is a sinusoidal current due to resonance between the inductor Lr and the capacitor C2. When the load current I3 becomes 0 A, the operation of the switching power supply 1 transitions from the sixth mode to the seventh mode.

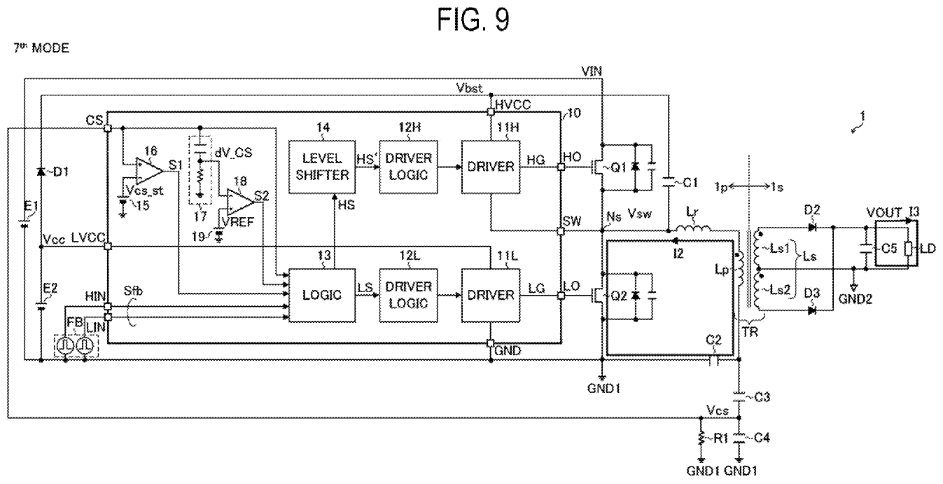

In the seventh mode, as in the sixth mode, the upper switch element Q1 enters the off-state and the lower switch element Q2 enters the on-state. As shown in FIG. 9, in the primary circuit system 1p, the load current I1 becomes 0 A, but the excitation current I2 continues to flow, and in the secondary circuit system 1s, the load current I3 flows from the capacitor C5 to the load LD. The excitation current I2 charges the capacitor C2. The longer a period of the seventh mode, that is, the longer a charging period of the capacitor C2, the greater the amount of charges stored in the capacitor C2, such that the DC output voltage VOUT rises.

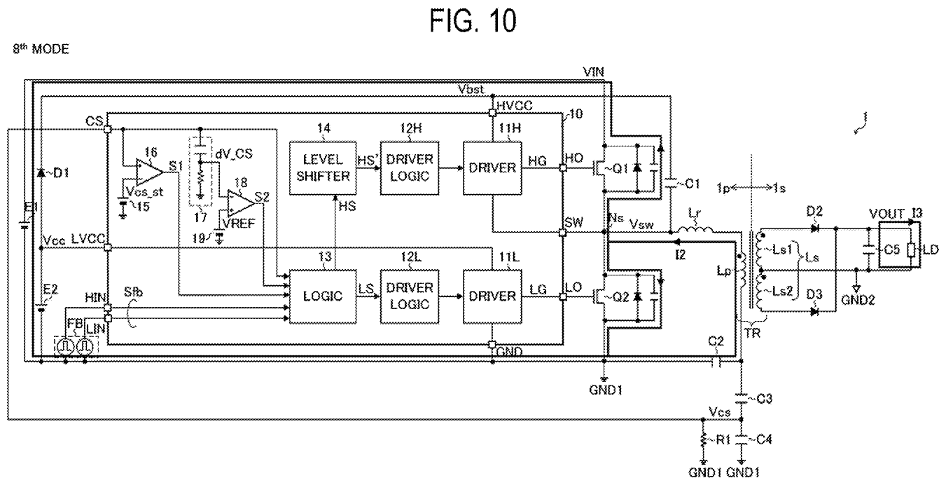

In the eighth mode subsequent to the seventh mode, the lower switch element Q2 switches from the on-state to the off-state. As shown in FIG. 10, in the primary circuit system 1p, the excitation current I2 starts to charge the output capacitance of the lower switch element Q2, and at the same time, the output capacitance of the upper switch element Q1 starts to discharge, and in the secondary circuit system 1s, the load current I3 flows from the capacitor C5 to the load LD. When the charging of the output capacitance of the lower switch element Q2 and the discharging of the output capacitance of the upper switch element Q1 are completed, the operation of the switching power supply 1 transitions from the eighth mode to the ninth mode.

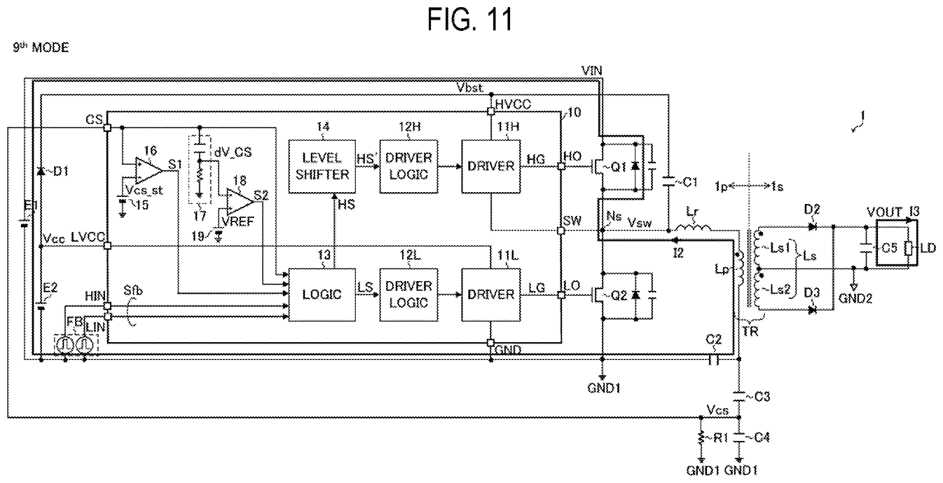

In the ninth mode, as shown in FIG. 11, in the primary circuit system 1p, the excitation current I2 flows through the body diode of the upper switch element Q1, and in the secondary circuit system 1s, the load current I3 flows from the capacitor C5 to the load LD. As the excitation current I2 flows through the body diode of the upper switch element Q1, the drain-source voltage of the upper switch element Q1 becomes approximately 0 V.

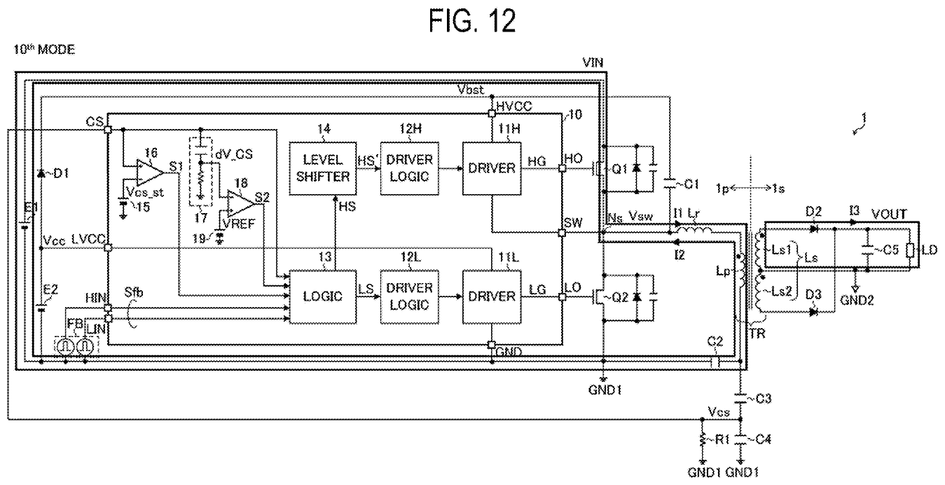

In the tenth mode subsequent to the ninth mode, the upper switch element Q1 switches from the off-state to the on-state. Since the excitation current I2 flows through the body diode of the upper switch element Q1 before the upper switch element Q1 switches from the off-state to the on-state, the turn-on operation of the upper switch element Q1 becomes the ZVS operation. The capacitor C2 functions as a power supply by being charged. As a result, as shown in FIG. 12, the load current I1 is generated in the primary circuit system 1p, and the load current I3 flows in the secondary circuit system 1s via the diode D2. The excitation current I2 flows in a direction opposite to a direction of the load current I1, but since a negative voltage is applied to the primary winding Lp, the excitation current I2 gradually decreases and eventually becomes a current in the same direction as in the load current I1.

### <Control in Activation>

In activation of the semiconductor device 10, that is, in activation of the switching power supply 1, the logic 13 performs the following control by using the comparison result signals S1 and S2.

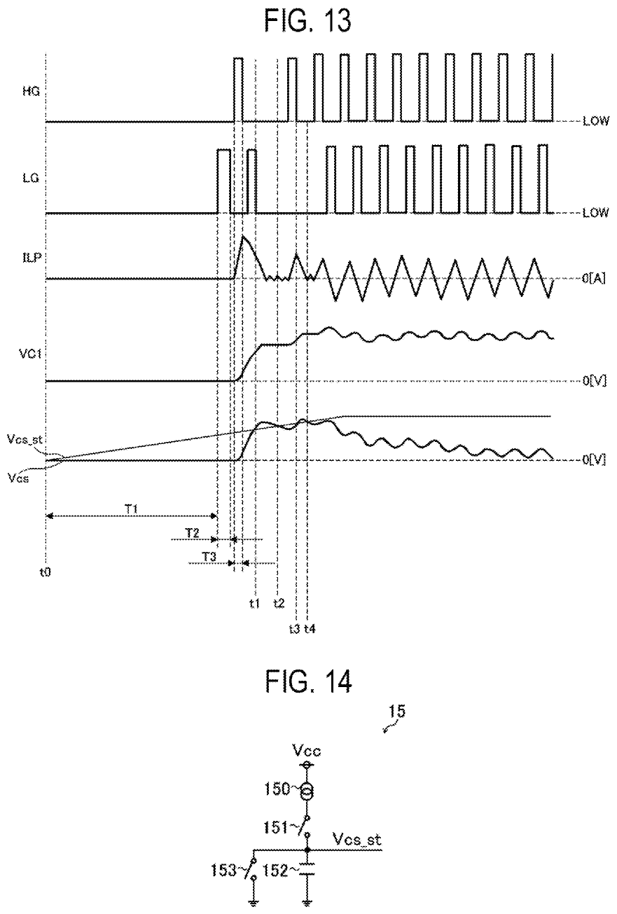

FIG. 13 is a diagram showing operation waveforms in activation of the switching power supply 1. FIG. 13 shows a waveform of the upper gate signal HG, a waveform of the lower gate signal LG, a waveform of a current ILP flowing through the primary winding Lp, a waveform of a potential difference VC1 between both ends of the capacitor C1, a waveform of the reference voltage Vcs_st, and a waveform of the voltage Ves which is a current sense signal.

At an activation start timing t0 of the switching power supply 1, that is, a timing at which the voltage source E1 starts to output the DC input voltage VIN and the voltage source E2 starts to output the power supply voltage Vcc, the voltage source 15 increases the reference voltage Vcs_st in a slope shape manner (gradually). Then, when n periods of a minimum switching period (reciprocal of the maximum switching frequency) of the upper switch element Q1 and the lower switch element Q2 have elapsed from an end timing of a first constant time T1, the voltage source 15 maintains the reference voltage Vcs_st constantly. The value of n is not particularly limited, but n is set to, for example, 3 or more and 5 or less.

When the first constant time T1 has elapsed from a timing t0, the logic 13 sets the upper gate signal HG to a low level so as to set the upper switch element Q1 to the off-state, and sets the lower gate signal LG to a high level so as to set the lower switch element Q2 to the on-state for a second constant time T2. During the second constant time T2, the capacitor C1, which functions as a power supply for the upper switch element Q1, is charged.

Thereafter, the logic 13 sets the upper gate signal HG to a high level so as to set the upper switch element Q1 to the on-state, and sets the lower gate signal LG to a low level so as to set the lower switch element Q2 to the off-state. Then, the logic 13 switches the upper gate signal HG from a high level to a low level so as to turn off the upper switch element Q1 when a constant time T3, which is set to be shorter than an on-time defined by the maximum switching frequency of the upper switch element Q1 and the lower switch element Q2, has elapsed after the upper switch element Q1 is turned on, or when the current sense signal Vcs exceeds the reference voltage Vcs_st, whichever occurs first. Due to this control, a first on-time of the upper switch element Q1 is limited, and overcharging of the capacitor C2 is prevented.

In a frequency modulation method used in the switching power supply 1, a maximum value of the switching frequency fsw (maximum switching frequency) is set, and an on-duty of the upper switch element Q1 and the lower switch element Q2 is also set. The on-duty of the upper switch element Q1 and the lower switch element Q2 is set to, for example, 50%. Accordingly, the on-time defined by the maximum switching frequency of the upper switch element Q1 and the lower switch element Q2 is the product of the reciprocal of the maximum switching frequency and the on-duty.

The constant time T3 is set to, for example, a half of the on-time defined by the maximum switching frequency of the upper switch element Q1 and the lower switch element Q2. Due to the setting, it is possible to prevent a potential difference between both ends of the capacitor C2 from becoming larger than half of the DC input voltage VIN.

In FIG. 13, the first on-time of the upper switch element Q1 is limited by the constant time T3.

After the first on-time of the upper switch element Q1 has terminated, when conditions that the current sense signal Vcs does not exceed the reference voltage Vcs_st and the voltage dV_CS output from the high-pass filter 17 is equal to or lower than the reference voltage (constant voltage) VREF are satisfied, the logic 13 controls the upper switch element Q1 and the lower switch element Q2 to be turned on and off in a complementary manner.

In FIG. 13, in a period from a timing t1 to a timing t2 and a period from a timing t3 to a timing t4, since the current sense signal Vcs exceeds the reference voltage Vcs_st, the logic 13 stops the switching control of the upper switch element Q1 and the lower switch element Q2, and sets both the upper switch element Q1 and the lower switch element Q2 to the off-state.

As described above, when the current sense signal Vcs exceeds the reference voltage Vcs_st in activation of the switching power supply 1, since the upper switch element Q1 enters the off-state, hard switching in a state where a current flowing through the primary winding Lp remains is avoided, and it possible to suppress the hard switching in activation.

FIG. 14 is a diagram showing a configuration example of the voltage source 15. The voltage source 15 shown in FIG. 14 includes a constant current source 150, a switch 151, a capacitor 152, and a switch 153. The power supply voltage Vcc is applied to a first end of the constant current source 150. A second end of the constant current source 150 is connected to a first end of the switch 151. A second end of the switch 151 is connected to first ends of the capacitor 152 and the switch 153. The ground voltage GND1 is applied to second ends of the capacitor 152 and the switch 153. The switches 151 and 153 are controlled by the logic 13. At an activation start timing t0 of the switching power supply 1, the switch 151 is turned on and the switch 153 is turned off. Then, when n periods of a minimum switching period (reciprocal of the maximum switching frequency) of the upper switch element Q1 and the lower switch element Q2 have elapsed from an end timing of the first constant time T1, the switch 151 is turned off. When the switching power supply 1 is shut down, the switch 153 is turned on.

### Others

The above-described embodiments should be considered to be illustrative in all respects and not restrictive, and it should be understood that the technical scope of the present disclosure is indicated by the appended claims, not by the description of the above-described embodiments, and all modifications falling within the meaning and scope equivalent to the appended claims are included.

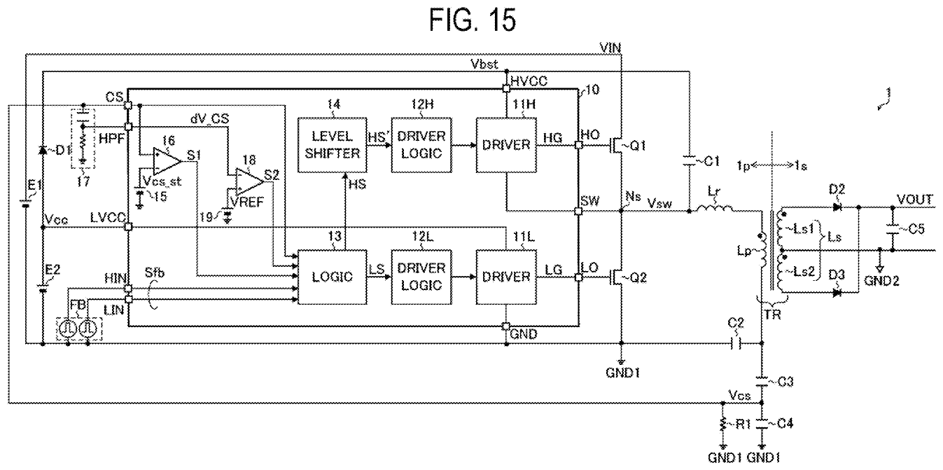

For example, as shown in FIG. 15, the high-pass filter 17 may be provided outside the semiconductor device 10, and an HPF pin to which the voltage dV_CS output from the high-pass filter 17 is applied may be provided in the semiconductor device 10.

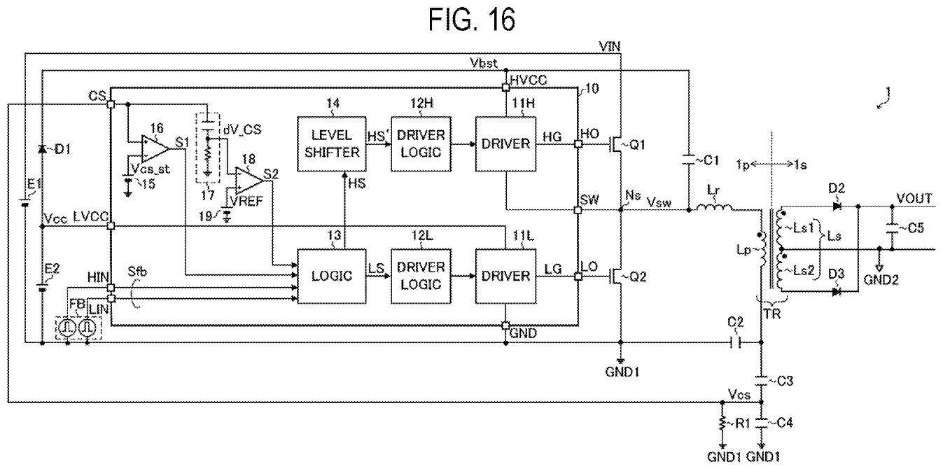

In addition, for example, in a case where the current mode control method is not applied, as shown in FIG. 16, the voltage Ves, which is the current sense signal, may not be supplied to the logic 13.

In addition, for example, the semiconductor device 10 may be configured not to determine the condition that the constant time T3, which is set to be shorter than the on-time defined by the maximum switching frequency of the upper switch element Q1 and the lower switch element Q2, has elapsed after the upper switch element Q1 is turned on.

In addition, for example, the semiconductor device 10 may be configured not to determine the condition that the voltage dV_CS output from the high-pass filter 17 is equal to or lower than the reference voltage (constant voltage) VREF.

### SUPPLEMENTARY NOTES

Supplementary notes are provided for the present disclosure in which specific configuration examples have been shown in the embodiments described above.

A power supply controller (10) according to the present disclosure is configured to control an operation of an LLC resonant converter including a first switch element (Q1) configured such that an input voltage (VIN) is applied to a first end of the first switch element (Q1), a second switch element (Q2) configured such that a first end of the second switch element (Q2) is connected to a second end of the first switch element, a primary winding (Lp) and a resonant capacitor (C2) configured to be connected in series between a first connection node (Ns) to which the second end of the first switch element and the first end of the second switch element are connected and a second end of the second switch element, a secondary winding (Ls) configured to be magnetically coupled to the primary winding, and a rectifier (D2, D3) configured to be connected to the secondary winding, the power supply controller including: a monitor terminal (CS pin) configured to receive a current sense signal (Vcs) corresponding to a current flowing through the primary winding (Lp); a voltage source (15) configured to generate a reference voltage (Vcs_st) that increases in a slope shape in activation; and a control circuit (13) configured to perform: a first control in which the first switch element is set to an off-state, and the second switch element is set to an on-state for a constant time in the activation, and a second control in which the first switch element is set to an on-state and the second switch element is set to an off-state after performing the first control, and when the current sense signal exceeds the reference voltage, the first switch element is turned off (first configuration).

According to the power supply controller of the first configuration, when the current sense signal exceeds the reference voltage, since the first switch element enters the off-state, hard switching in a state where a current flowing through the primary winding remains is avoided, and it possible to suppress the hard switching in the activation.

The power supply controller of the first configuration may further include a first comparator (16) configured to compare the current sense signal and the reference voltage (second configuration).

In the power supply controller of the first configuration or the second configuration, in the second control, the control circuit may be configured to set the first switch element to the on-state and the second switch element to the off-state after performing the first control, and may be configured to turn off the first switch element when the constant time, which is set to be shorter than an on-time defined by a maximum switching frequency of the first switch element and the second switch element, has elapsed after turning on the first switch element, or when the current sense signal exceeds the reference voltage, whichever occurs first (third configuration).

In the power supply controller of the third configuration, the constant time may be half of the on-time defined by the maximum switching frequency of the first switch element and the second switch element (fourth configuration).

In the power supply controller of any of the first to fourth configurations, the control circuit may be configured to control each of the first switch element and the second switch element to be turned on and off in a complementary manner when conditions that the current sense signal does not exceed the reference voltage and a voltage (dV_CS) output from a high-pass filter (17) configured to receive the current sense signal is equal to or lower than a constant voltage (VREF) are satisfied after performing the second control (fifth configuration).

The power supply controller of the fifth configuration may further include the high-pass filter (sixth configuration).

The power supply controller of the fifth configuration or the sixth configuration may further include a second comparator (18) configured to compare the voltage output from the high-pass filter (17) and the constant voltage (seventh configuration).

A switching power supply (1) according to the present disclosure includes: the power supply controller according to any one of the first to seventh configurations; and the LLC resonant converter (eighth configuration).

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A power supply controller configured to control an operation of an LLC resonant converter including a first switch element configured such that an input voltage is applied to a first end of the first switch element, a second switch element configured such that a first end of the second switch element is connected to a second end of the first switch element, a primary winding and a resonant capacitor configured to be connected in series between a first connection node to which the second end of the first switch element and the first end of the second switch element are connected and a second end of the second switch element, a secondary winding configured to be magnetically coupled to the primary winding, and a rectifier configured to be connected to the secondary winding, the power supply controller comprising:
a monitor terminal configured to receive a current sense signal corresponding to a current flowing through the primary winding;
a voltage source configured to generate a reference voltage that increases in a slope shape in activation; and
a control circuit configured to perform:
a first control in which the first switch element is set to an off-state, and the second switch element is set to an on-state for a constant time in the activation, and
a second control in which the first switch element is set to an on-state and the second switch element is set to an off-state after performing the first control, and when the current sense signal exceeds the reference voltage, the first switch element is turned off.

2. The power supply controller according to claim 1, further comprising:
a first comparator configured to compare the current sense signal and the reference voltage.

3. The power supply controller according to claim 1, wherein in the second control, the control circuit is configured to set the first switch element to the on-state and the second switch element to the off-state after performing the first control, and is configured to turn off the first switch element when the constant time, which is set to be shorter than an on-time defined by a maximum switching frequency of the first switch element and the second switch element, has elapsed after turning on the first switch element, or when the current sense signal exceeds the reference voltage, whichever occurs first.

4. The power supply controller according to claim 3, wherein the constant time is half of the on-time defined by the maximum switching frequency of the first switch element and the second switch element.

5. The power supply controller according to claim 2, wherein the control circuit is configured to control each of the first switch element and the second switch element to be turned on and off in a complementary manner when conditions that the current sense signal does not exceed the reference voltage and a voltage output from a high-pass filter configured to receive the current sense signal is equal to or lower than a constant voltage are satisfied after performing the second control.

6. The power supply controller according to claim 5, further comprising:
the high-pass filter.

7. The power supply controller according to claim 5, further comprising:
a second comparator configured to compare the voltage output from the high-pass filter and the constant voltage.

8. A switching power supply, comprising:
the power supply controller according to claim 1; and
the LLC resonant converter.
